(19) United States
(12) Patent Application Publication
(10) Pub. No.: US 2008/0122789 A1
(43) Pub. Date: May 29, 2008

(54) POINTING DEVICE WITH A RESOLUTION-SETTING HOTKEY AND A SETTING METHOD THEREOF

(75) Inventors: Tzu-Chiang Shih, Taipei (TW); Chih-Hung Lin, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/624,058

(22) Filed: Jan. 17, 2007

(30) Foreign Application Priority Data
Nov. 24, 2006 (TW) 095143506

(51) Int. Cl. G06F 3/033

(52) U.S. Cl. 345/162

(57) ABSTRACT

Present invention provides a pointing device with a resolution-setting hotkey and a setting method thereof. The pointing device comprises a resolution-setting hotkey, a microprocessor and an optical sensor. The present pointing device has a default x-axis resolution and a default y-axis resolution and they are of the same value. By pressing the hotkey, a resolution-adjusting signal is generated to make the x-axis resolution is different from the y-axis resolution.

### FIELD OF THE INVENTION

The present invention relates to a pointing device with a resolution-setting hotkey and a setting method thereof, and more particularly to a pointing device and a method for adjusting an x-axis resolution and a y-axis resolution by the resolution-setting hotkey without installing any drivers, so the present invention is suitable for wide screens.

### BACKGROUND OF THE INVENTION

Nowadays, owing to the popularity of window operation system and personal computer, the use of mouse is getting more essential when operating a computer. Besides, owing to the improvement of screens, the resolution of screen is getting higher and higher. In the past, the resolutions of screens include QVGA (320*240 dpi), VGA (640*480 dpi), SVGA (800*600 dpi), XGA (1024*768 dpi), SXGA (1280*1024 dpi), UXGA (1600*1200 dpi). In general, the ratio of width to height of the foregoing screens is around 4:3. However, from the perspective of human's visional property, wide screens are better than the foregoing screens since the length of the screen's width is longer than that of the screen's height. In general, the ratio of width to height of wide screens is around 16:10. Therefore, 4:3 ratio screens are gradually replaced by wide screens. Because the width and the height of the 4:3 ratio screens is very close, the x-axis resolution and the y-axis resolution of the mouse for controlling the cursor of the screen is the same. In the prior art, the x-axis resolution and the y-axis resolution of the mouse must be increased/decreased in the same interval, such as from (800*800 dpi) to (1024*1024 dpi).

However, for wide screens, the x-axis resolution and the y-axis resolution of the mouse have to be different to match the width length and the height length respectively. In the prior art, users can change the x-axis resolution and the y-axis resolution respectively by setting a driver installed in a computer. But it is not convenient for users because they must to set the driver by themselves. For this reason, the present invention provides a pointing device with a resolution-setting hotkey. By pressing the hotkey, users can immediately adjust the x-axis resolution and the y-axis resolution of the pointing device to have the x-axis resolution higher than the y-axis resolution, in order to meet the requirement for wide screens.

### SUMMARY OF THE INVENTION

It is an object of the present invention to provide a pointing device with a resolution-setting hotkey and a setting method thereof, and more particularly to a pointing device and a method, which can adjust x-axis resolution and y-axis resolution by the resolution-setting hotkey without installing any drivers so as to meet the requirement for wide screens.

According to a preferred embodiment of this invention, a pointing device with a resolution-setting hotkey is disclosed. The pointing device has a default x-axis resolution and a default y-axis resolution and said default x-axis resolution and said default y-axis resolution are of the same value, characterized in that the pointing device has a resolution-setting hotkey for generating a resolution-adjusting signal to increase the default x-axis resolution to a new x-axis resolution, wherein the new x-axis resolution is different from the default y-axis resolution.

In a preferred embodiment, the pointing device further comprises an optical sensor for detecting movement of the pointing device and a microprocessor for receiving the resolution-adjusting signal and performing an operation to increase the default x-axis resolution to the new x-axis resolution and the new x-axis resolution is higher than the default y-axis resolution. The operation is interpolation.

In a preferred embodiment, the pointing device further comprises a microprocessor for receiving said resolution-adjusting signal and generating an adjusting signal, and an optical sensor for detecting movement of the pointing device and for receiving the adjusting signal from the microprocessor, wherein the optical sensor increase the default x-axis resolution to a new x-axis resolution in response to the adjusting signal and the new x-axis resolution is higher than said default y-axis resolution.

In a preferred embodiment, the pointing device is an optical mouse.

The present invention also disclosed a method for adjusting resolution of a mouse for wide screen, wherein said mouse has an x-axis resolution and a y-axis resolution, and the method comprises a first step of pressing a hotkey configured in the mouse, and a second step of enabling an operation in a microprocessor of the mouse for increasing the x-axis resolution higher than the y-axis resolution. The operation is interpolation.

In another embodiment of the present invention, a method for adjusting resolution of mouse for wide screen is disclosed. The mouse has an x-axis resolution and a y-axis resolution. The method comprises a first step of pressing a hotkey configured in said mouse, and a second step of adjusting the x-axis resolution of an optical sensor in the mouse so as to increase the x-axis resolution higher than the y-axis resolution.

### BRIEF DESCRIPTION OF THE DRAWINGS

FIG. 1 is a schematic block diagram of a pointing device according to a preferred embodiment of the present invention;

FIG. 2 is a flowchart of the preferred embodiment of FIG. 1;

FIG. 3 is a schematic block diagram of a pointing device according to another preferred embodiment of the present invention; and

FIG. 4 is a flowchart of the preferred embodiment of FIG. 3.

### DETAILED DESCRIPTION OF THE PREFERRED EMBODIMENT

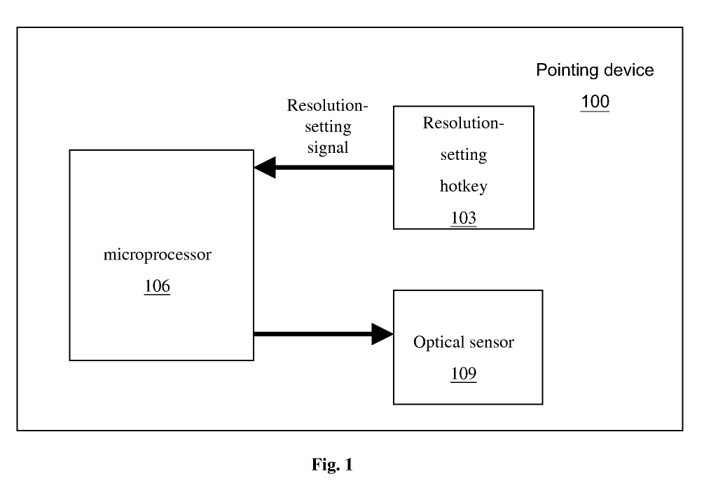

Referring to FIG. 1, a schematic block diagram of a pointing device according to a preferred embodiment of the present invention is disclosed. In the present embodiment, the pointing device 100 comprises a resolution-setting hotkey 103, a microprocessor 106, and an optical sensor 109.

When the users operate a personal computer with a wide screen, users press the resolution-setting hotkey 103 to send a resolution-setting signal to the microprocessor 106. After the resolution-setting signal is received by the microprocessor 106, an interpolation program stored in the microprocessor 106 is performed. In the present embodiment, the default x-axis resolution and the default y-axis resolution of the optical sensor 109 are of the same value, such as 800 dpi for both. The optical sensor 109 is controlled by the microprocessor 106 to detect movement of the pointing device 100.

The default x coordinate and default y coordinate are detected by the optical sensor 106, and sent to the microprocessor 106. Then, the x-axis resolution is interpolated by the microprocessor 106 to be increased from 800 dpi to a new x-axis resolution, such as 1280 dpi. Next, the microprocessor 106 calculates a new x coordinate according to the 1280 dpi of the new x-axis resolution and the default x coordinate. Finally, the new x coordinate and the default y coordinate are sent to a personal computer (not shown) by the microprocessor 106, and a cursor movement is shown on a screen (not shown) by the personal computer. Comparing the cursor's moving distances of new x resolution (1280 dpi) with that of the default x resolution (800 dpi), upon the pointing device 100 is moved, the cursor is horizontally moved for a longer distance in the case of 1280 dpi than that of 800 dpi.

According to the above description, in the present embodiment, users enable the interpolation program in the microprocessor 106 for x-axis resolution by pressing the hotkey 103. And the x-axis resolution and the y-axis resolution are adjusted from 800*800 dpi to 1280*800 dpi for wide screens.

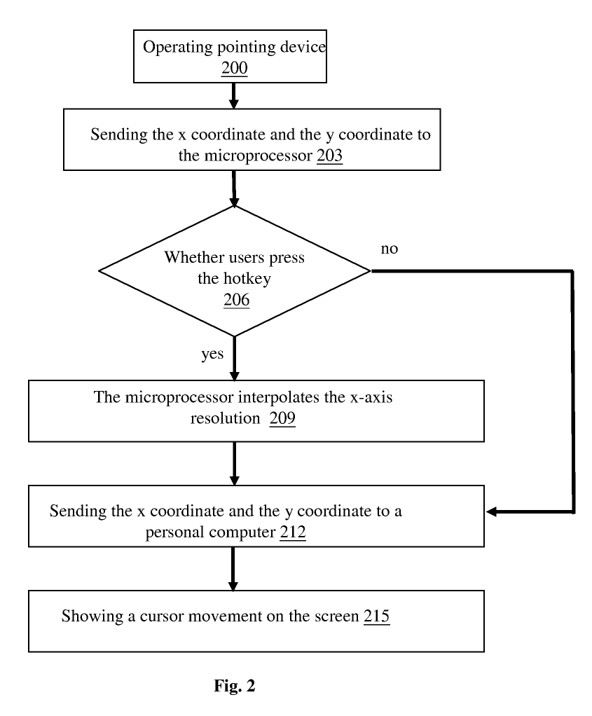

Referring to FIG. 2, a flowchart of the embodiment of the FIG. 1 is shown. In step 200, users start to operate the pointing device. In step 203, the optical sensor in the pointing device send a default x coordinate and a default y coordinate to the microprocessor. In step 206, judging whether users press the hotkey or not. If yes, performing step 209, otherwise, performing step 212. In step 209, the microprocessor interpolates the x-axis resolution to increase from 800 dpi to 1280 dpi, and the y-axis resolution is kept in 800 dpi, then performing step 212. In step 212, the microprocessor separately calculates the x coordinate and the y coordinate of the cursor on the screen according to the default x coordinate, the default y coordinate, the x-axis resolution and the y-axis resolution and sends them to the personal computer. Finally in step 215, a cursor movement is shown on the screen by the personal computer.

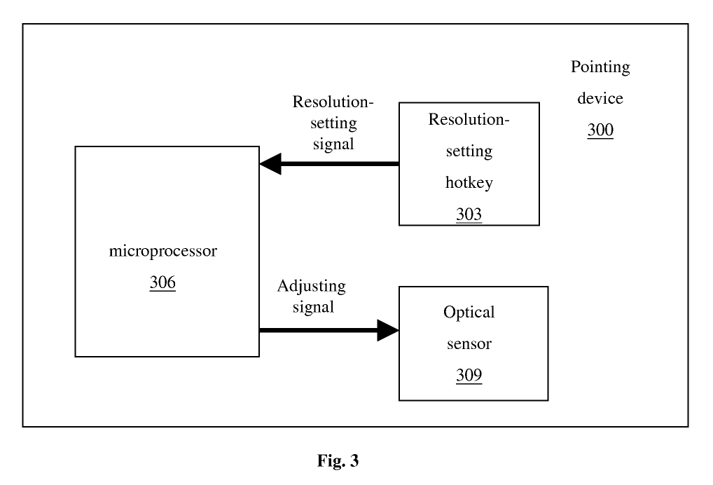

Referring to FIG. 3, a schematic block diagram of a pointing device according to another preferred embodiment of the present invention is shown. In the present embodiment, the pointing device 300 comprises a resolution-setting hotkey 303, a microprocessor 306, and an optical sensor 309. When users press the resolution-setting hotkey 303, a resolution-setting signal is sent to the microprocessor 306. After the resolution-setting signal is received by the microprocessor 306, an adjusting signal is sent to the optical sensor 309 by the microprocessor 306. The default x-axis resolution and the default y-axis resolution of the optical sensor 309 are both 800 dpi. After the optical sensor 309 receives the adjusting signal, the x-axis resolution is increased from 800 dpi to 1280 dpi, and the y-axis resolution is kept in 800 dpi.

According to the x-axis resolution and the y-axis resolution, the x coordinate and the y coordinate are detected by the optical sensor 309 and are sent to the microprocessor 306. Finally, the x coordinate and the y coordinate are sent to a personal computer (not shown) by the microprocessor 306, and a cursor movement is shown on a screen (not shown) by the personal computer.

According to the above description, in the second embodiment of the present invention, users increase the x-axis resolution of the optical sensor 309 to 1280 dpi, and keep the y-axis resolution in 800 dpi. Next, the x coordinate and the y coordinate are detected according to the x-axis resolution and the y-axis resolution and a cursor movement is shown on the screen.

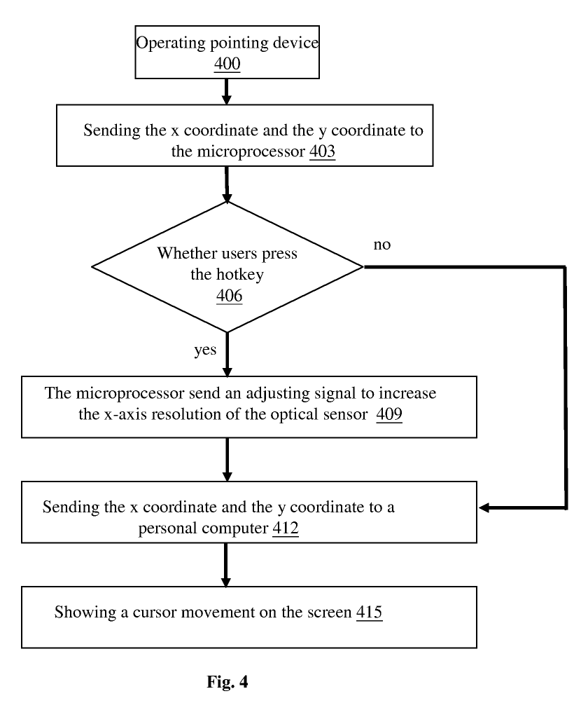

Referring to FIG. 4, a flowchart of the embodiment of the FIG. 3 is shown. In step 400, users start to operate the pointing device. In step 403, the optical sensor in the pointing device sends a default x coordinate and a default y coordinate to the microprocessor. In step 406, judging whether users press the hotkey or not. If yes, performing step 409, otherwise, performing step 412. In step 409, an adjusting signal is sent by the microprocessor to the optical sensor, in order to increase the x-axis resolution from 800 dpi to 1280 dpi, and the y-axis resolution is kept in 800 dpi, then performing step 412. In step 412, the microprocessor separately calculates the x coordinate and the y coordinate of the cursor on the screen according to the default x coordinate, the default y coordinate, the x-axis resolution and the y-axis resolution and sends them to the personal computer. Finally in step 215, the cursor movement is shown on the screen by the personal computer.

In present invention, the x-axis resolution is not merely limited to be increased from 800 dpi to 1280 dpi. The scope of present invention comprises any embodiments that the x-axis resolution is increased higher than the y-axis resolution by pressing a hotkey of a pointing device. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims that are to be accorded with the broadest interpretation so as to encompass all such modifications and similar structures.

What is claimed is:

1. A pointing device with a resolution-setting hotkey, having a default x-axis resolution and a default y-axis resolution and said default x-axis resolution and said default y-axis resolution are of the same value, characterized in that:
said pointing device has a resolution-setting hotkey for generating a resolution-adjusting signal to increase said default x-axis resolution to a new x-axis resolution, wherein said new x-axis resolution is different from said default y-axis resolution.

2. The pointing device with a resolution-setting hotkey according to claim 1, further comprising:
an optical sensor for detecting movement of said pointing device; and
a microprocessor, for receiving said resolution-adjusting signal and performing an operation to increase said default x-axis resolution to said new x-axis resolution and said new x-axis resolution is higher than said default y-axis resolution.

3. The pointing device with a resolution-setting hotkey according to claim 2, wherein said operation is interpolation.

4. The pointing device with a resolution-setting hotkey according to claim 1, further comprising:
a microprocessor, for receiving said resolution-adjusting signal and generating an adjusting signal; and
an optical sensor, for detecting movement of said pointing device and for receiving said adjusting signal from said microprocessor, wherein said optical sensor increase said default x-axis resolution to a new x-axis resolution in response to said adjusting signal and said new x-axis resolution is higher than said default y-axis resolution.

5. The pointing device with a resolution-setting hotkey according to claim 1, wherein said pointing device is an optical mouse.

6. A method for adjusting resolution of a mouse for wide screen, wherein said mouse has an x-axis resolution and a y-axis resolution, and said method comprising:
pressing a hotkey configured in said mouse; and
enabling an operation in a microprocessor of said mouse for increasing said x-axis resolution higher than said y-axis resolution.

7. The method for adjusting resolution of mouse for wide screen according to claim 6, wherein said operation is interpolation.

8. A method for adjusting resolution of mouse for wide screen, wherein said mouse has an x-axis resolution and a y-axis resolution, and said method comprising:
pressing a hotkey configured in said mouse; and
adjusting said x-axis resolution of an optical sensor in said mouse so as to increase said x-axis resolution higher than said y-axis resolution.
